(19) United States
(12) Patent Application Publication
(10) Pub. No.: US 2026/0073444 A1
(43) Pub. Date: Mar. 12, 2026

(54) SYSTEM, METHOD AND APPARATUS FOR EMPLOYING MACHINE LEARNING TO PREVENT PAYMENT FAILURES

(71) Applicant: Affirm, Inc., San Francisco, CA (US)

(72) Inventors: Kyle Gahagan, San Francisco, CA (US); Francisco Javier Arceo, San Francisco, CA (US); Jiahui Ying, San Francisco, CA (US); Jiarui Xu, San Francisco, CA (US)

(21) Appl. No.: 18/827,745

(22) Filed: Sep. 7, 2024

(51) Int. Cl. G06Q 20/22; G06N 20/00; G06Q 20/40

(52) U.S. Cl. CPC G06Q 40/0305; G06Q 20/227; G06Q 20/403; G06Q 40/03055

(57) ABSTRACT

A method for automatically avoiding failed customer payments with respect to electronic fund transfers may include receiving, by a facilitation agent, account transaction data associated with payments attempted with respect to a plurality of payment instruments for a plurality of customers, employing a machine learning platform to determine a predicted suitability rating for each of the plurality of payment instruments for the plurality of customers, transmitting a message to a selected one of the customers to provide an interface console with payment instrument options displayed based on the predicted suitability rating, and in response to selection of a payment instrument option by the selected one of the customers, modifying a payment source associated with a future payment to be made to a selected payment instrument associated with the selected payment instrument option.

### TECHNICAL FIELD

Example embodiments generally relate to financial industry technologies and, in particular, relate to apparatuses, systems, and methods for providing technical tools to monitor and act to avoid payment failures in connection with automatic payments.

### BACKGROUND

The financial industry is comprised of many thousands of customers, vendors, lenders, borrowers, and other role players that all interact in various ways to enable customers to ultimately have access to goods and services provided by vendors. Credit and financial transactions have long been a way that individuals have managed point of sale transactions to ensure seamless transfer of funds from customers, or on their behalf, to vendors for relatively routine or small transactions. Meanwhile, obtaining a loan from a bank has long been the most common way of obtaining financing for non-routine or larger transactions. More recently, installment loan financing has become a popular option.

Credit cards and certain other lending vehicles may be useful tools for many customers. However, some customers can find themselves over extended either quickly or over a period of time based on the existing tools. This phenomenon has repeated itself over generations, and for millions of customers. Thus, there is now a deep desire on the part of many to create flexible and fair means of supporting customer purchasing activities that is both honest and transparent, and that also improves the lives of customers.

Recently, many financial institutions have issued customers a payment card (e.g., a physical or virtual credit or debit card or other value card) to enable the customers to initiate transactions either supported by a customer account or linked to one or more loans. In many cases, the payment card may be linked to an account (e.g., a checking or savings account) that can be used to fund transactions via money transfers into or out of the account. The money transfers may include, for example, Automated Clearing House (ACH) transfers or payments among other electronic fund transfer vehicles.

Particularly in cases where a transaction is supported by a loan or other extension of short term or long term credit, it has become common for card issuers or other transaction facilitators to enable the customer to set up an automatic payment schedule in order to repay the loan. The systems that support automatic payments of this type are very often at least notionally popular with customers and banks or loan facilitators, since they can sometimes reduce fees, interest and complexity for customers (i.e., borrowers) while also reducing risks for lenders. However, in spite of the potential for mutual benefit for both borrowers and lenders, even automatic payment systems can often underperform and disappoint all parties due to failed payments that may occur with some frequency. The failed payments can happen for a lot of reasons, but regardless of the reason, they can frustrate and have negative financial impacts for all parties. Accordingly, again all parties may have an interest in avoiding failed automatic payments. However, doing so is a huge technical challenge that has not been addressable to date. Example embodiments aim to provide technical tools that are capable of addressing this challenge.

### BRIEF SUMMARY OF SOME EXAMPLES

In an example embodiment, a method for automatically avoiding failed customer payments with respect to electronic fund transfers may be provided. The method may include receiving, by a facilitation agent, account transaction data associated with payments attempted with respect to a plurality of payment instruments for a plurality of customers, employing a machine learning platform to determine a predicted suitability rating for each of the plurality of payment instruments for the plurality of customers, transmitting a message to a selected one of the customers to provide an interface console with payment instrument options displayed based on the predicted suitability rating, and in response to selection of a payment instrument option by the selected one of the customers, modifying a payment source associated with a future payment to be made to a selected payment instrument associated with the selected payment instrument option.

In another example embodiment, an apparatus for automatically avoiding failed customer payments with respect to electronic fund transfers may be provided. The apparatus may include processing circuitry configured for receiving, by a facilitation agent, account transaction data associated with payments attempted with respect to a plurality of payment instruments for a plurality of customers, employing a machine learning platform to determine a predicted suitability rating for each of the plurality of payment instruments for the plurality of customers, transmitting a message to a selected one of the customers to provide an interface console with payment instrument options displayed based on the predicted suitability rating, and in response to selection of a payment instrument option by the selected one of the customers, modifying a payment source associated with a future payment to be made to a selected payment instrument associated with the selected payment instrument option.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for automatically avoiding failed customer payments with respect to electronic fund transfers according to an example embodiment;

FIG. 2 illustrates a functional block diagram of a payments platform according to an example embodiment;

FIG. 3A illustrates a block diagram showing control flow associated with transaction settlement flow in accordance with an example embodiment;

FIG. 3B is a control console that may be generated in accordance with an example embodiment;

FIG. 3C shows a control console modified based on predicted suitability rating in accordance with an example embodiment;

FIG. 3D shows the control console of FIG. 3C further modified to include the predicted suitability rating in accordance with an example embodiment;

FIG. 3E shows the control console of FIG. 3D further modified to enable the user to always default to the best payment instrument in accordance with an example embodiment;

FIG. 4 illustrates a block diagram showing system interactions in accordance with an example embodiment; and

FIG. 5 illustrates a block diagram of a method for automatically avoiding failed customer payments with respect to electronic fund transfers in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

In today's world, the relationship between a lender or creditor and a borrower is sometimes experienced by the borrower as being a one-sided relationship. High fees for successful or failed transactions, and high interest rates can sometimes be charged to borrowers, and make them feel an adversarial relationship with their lenders/creditors. However, successful and even long term or loyal relationships can be established between borrowers and lenders if the relationship is centered on activities that are mutually beneficial, thereby defining a win-win scenario. Particularly when the borrower can see and appreciate the benefit to themselves, their relationship with the lender/creditor may be strengthened.

In the recent past, technological tools have been employed to enable lenders/creditors to define ways to maximize the likelihood that the lender/creditor gets paid back by the borrower, or maximize the profit made on payments received from the borrower. However, if that focus were shifted slightly, to instead a focus on avoiding the incidence of failure of automatic payments from the borrower's account, the borrower would undoubtedly benefit by the avoidance of fees and interest. The benefit to the borrower in terms of saving money, avoiding interest and/or having continued access to credit is obvious. But the lender/creditor may also benefit through increased loyalty and increased transaction volume as time goes on, thereby creating the potential for a win-win scenario.

In light of the discussion above, it should also be understood that the lender/creditor is sometimes, but not always, also the facilitator of the transaction forming the basis for the lending/borrowing relationship. The facilitator of the transaction may therefore be, for example, a card manager in the case of a virtual or physical credit or debit card (e.g., a payment card). However, regardless of whether the facilitator is the lender or not, the facilitator often plays a unique and interesting role in the lender/borrower relationship. In this regard, borrowers have significant options they can exercise in relation to the payment vehicle they choose to use for automatic payment setup. Which card they pull from their physical or virtual wallet, or which account they attempt to establish as the resource for making an automatic payment is an important decision to the transaction facilitators in the marketplace. Causing the borrower to favor your business as his/her payment vehicle of choice is therefore a powerful incentive. Having borrowers come to know that your business has the technical tools, and the organizational focus, to employ those tools to their benefit, may therefore be a significant driver of transaction volume and customer loyalty.

This brings us to the technical tools themselves. For many payment facilitators (who may or may not also be lenders), computer systems are defined that employ mathematical models to power decision making with respect to approving or denying a transaction that is attempted for a payment card (which is just one example of a payment instrument to which example embodiments may apply) or other electronic transactions supported by loans or credit extension. The financial bottom line may therefore often depend directly on the accuracy of the model with respect to predicting whether the funding of the transaction is above or below some risk threshold associated with the likelihood of getting paid back. Thus, the financial industry is often focused on developing strong models for predicting risk of default on loan repayment that tend to categorize or consider very strongly the behavior of the borrower. If the desired outcome is not merely making a binary choice regarding whether to deny or accept a transaction based on information about the borrower to minimize risk, but instead further on handling the transaction via a pathway that avoids or minimizes the likelihood of a failed automatic payment, fees that will be incurred by the customer (borrower) may be reduced. However, the complexity of the mathematical problem involved in solving this problem may skyrocket because it becomes necessary to consider the behavior of the banks or lenders involved in the transaction (not just for this customer, but in the aggregate). Moreover, these decisions must be made in very short periods of time.

Accordingly, example embodiments may employ machine learning tools that operate on massive amounts of data to continuously learn and update models associated with defining payment processing pathways to avoid or minimize the likelihood of a failed automatic payment. In this regard, as a payment facilitator that facilitates payments for a multitude of customers that each have their own respective banks and accounts that are associated with different payment vehicles, the facilitator has an interesting and potentially useful view of the results of various electronic fund transfer events. However, the view may be a confused and chaotic view that includes vast numbers of differently formatted signals of sometimes unknown and perhaps inconsistent meaning.

Example embodiments may therefore define and employ a robust machine learning (ML) platform operated by a facilitator, positioned to monitor the activity (i.e., signals) being witnessed for patterns indicative of the reliability of accounts or other payment vehicles (or payment instruments) that are linked to automatic payment systems. The facilitator may therefore make accurate predictions about the ability of the linked accounts or payment vehicles to be successfully accessed for automatic payment relative to other potentially linkable accounts associated with each of a multitude of customers (borrowers). The ML platform may, for example, develop a ranking of the best instruments or payment vehicles (e.g., accounts, cards, etc.) that may be used for automatic payments. In some cases, the customer may be informed of the ranking (or at least the best or better payment vehicles than the one or ones currently set up for usage). The customer may then be provided with the ability to change the payment vehicle to be used for automatic payment via interaction with a display specifically set up to provide the necessarily information and functionality to enable the appropriate interaction with the customer.

The ML platform may include a payment vehicle (or instrument) ranking engine that monitors payment vehicle activity over time for multitudes of transactions and therefore multitudes of customers and their respective accounts (at various banks) and payment vehicles. The payment vehicles may include any linked account, credit card, debit card or other payment instrument that may be used to make an automatic payment or other payment (e.g., a one-time (manual) payment or pay now transaction with a debit or other payment card). The payment vehicle ranking engine may search for patterns in signals (as noted above, which are often in various different and potentially unstructured formats) that indicate that a payment vehicle has been used (or attempted to be used). The context of the use including the timing of usage and any of various other situational factors relating to the use of the payment vehicle may also be determined in some cases. Thus, for example, if the attempt to use the payment vehicle either succeeded or failed when used for a payment, the payment vehicle ranking engine may be aware of such success or failure (along with perhaps other context information describing other situational factors). In some cases, the other situational factors may include a determination that a fee has been charged to a customer or a cost charged to the facilitator in connection with making a payment. The likelihood of success in making future automatic payments (and/or the costs/fees of making such payments with a given payment vehicle) may then be determined by the payment vehicle ranking engine and the payment vehicles may be ranked according to a predicted success rating, a predicted cost rating, or some combination thereof, which may be referred to as a predicted suitability rating.

As an alternative to a simple rating (or ranking), or as a part of such rating, the payment vehicle ranking engine may determine an instrument profile for each payment vehicle associated with a given customer. The instrument profile may include information about the payment vehicle (or instrument) such as age, last usage, success or failure rate (which may further be segmented temporally into different periods over the age of the instrument), costs/fees associated with usage, etc.

The ML platform may also include a display generator that generates an interface console tailored to the purpose of soliciting input from the customer regarding ordering of payment vehicle options or selection of a payment vehicle option. The interface console may have content, but in some cases also form, that is tailored specifically to each individual customer to encourage or convince the customer to make changes to payment vehicle selection options. In this regard, the interface console may not only list the options available according to their rating (under one or more of the criteria via which ranking may occur), but the interface console may also provide cost, failure rate, or other information that assists the customer in evaluation of the value or savings that may be achieved by making a given change.

Of note, with respect to the components described above (e.g., the payment vehicle ranking engine and the display generator), each component may employ respective models that are updated continuously and automatically via machine learning employed by the ML platform 70. Thus, for example, machine learning may be employed for defining a model updating engine that continuously learns on the massive volumes of real time data that are being monitored. The model updating engine may work specifically to strengthen the models by ranking the strength of certain signals or signal patterns that are encountered or employed for each of the models. In this regard, the strongest signals and patterns may therefore be relied upon most heavily with respect to each model being employed. The model updating engine may specifically, in some cases, be configured to update a payment vehicle ranking model and/or a display generation model to strengthen the models (which apply across a multitude of customers), so that the performance of each model for each individual customer is improved.

Some example embodiments described herein provide for a payments platform that can be instantiated at an apparatus comprising configurable processing circuitry, and which may process various pay now, pay later, credit, debit, or other financial transactions involving electronic funds transfer. The processing circuitry may be configured to execute various processing functions on financial data using the techniques described herein. The payments platform may, for example, be configured to provide a way to determine, for an individual user, for individual banks, and even sometimes on a product-level basis, whether the payment options (e.g., payment vehicles or instruments) available for making payments (e.g., automatic payments) are likely to be successfully employed and/or whether fees will be likely to be incurred for electronic fee transfers associated with them. Thus, for example, a prediction of whether a fee is likely to be charged for use of a particular payment vehicle and/or whether a payment will be likely to be successfully made using the payment vehicle may be made using technical tools provided by example embodiments.

Example embodiments therefore use technical means embedded into information exchange, to further enable technical computation or calculation that improves the entire process massively (e.g., by avoiding payment failures or otherwise avoidable fees). This technical assistance to customers, which saves both them and the transaction facilitator money and reputation, may be game changing in terms of customer satisfaction while also driving increased sales volume, without a corresponding appreciable increase in risk. The user can therefore experience the benefits of continued positive (e.g., relationship enhancing) behaviors, and the card issuer/transaction facilitator can build a loyal customer base of satisfied card users by using technical means to leverage benefit to the customer. Moreover, whereas the technical tools are ultimately used to avoid failed payments or a fee, as will be outlined in greater detail below, the real technical challenge that is ultimately solved by example embodiments is to wade through a morass of complicated and unstructured signaling from many different organizations, and determine from that mass of information a profile for a bank, customer or product that relates to payment instrument or vehicle success rates and fees, so that payment failures and costs/fees (whether paid by customer or facilitator) can later be avoided. Whereas strategies for avoiding costs/fees may themselves be executed by a general purpose computer, the identification of payment vehicle success rates, fees charged, and interaction with customers to drive action in relation to either or both of those issues is impossible in today's environment without the additional powerful machine learning tools described herein.

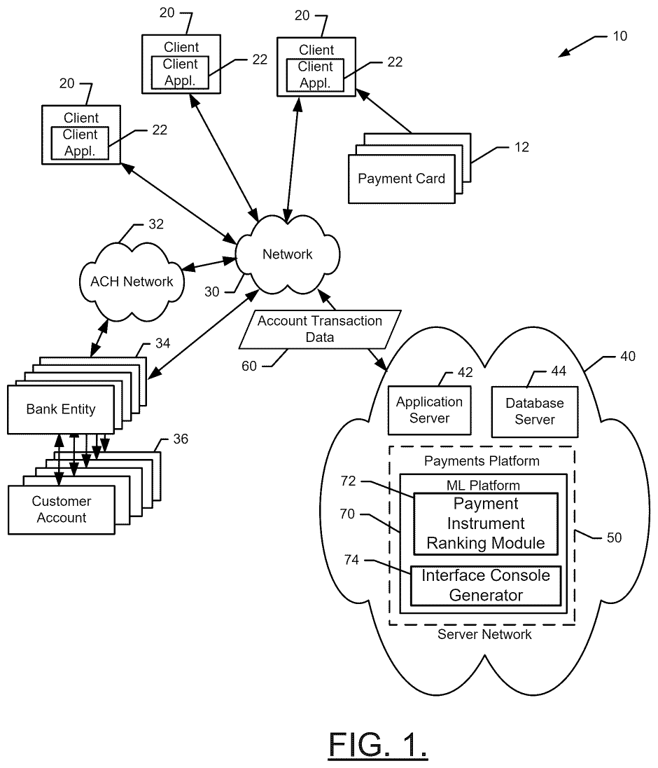

An example embodiment of the invention will now be described in reference to FIG. 1, which illustrates an example system in which an embodiment of the present invention may be employed. As shown in FIG. 1, a transaction management system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The clients 20 may, in some cases, each be associated with a single computer or computing device that is capable of executing software programmed to implement example embodiments. Thus, in some embodiments, one or more of the clients 20 may be associated with an organization (e.g., a merchant company) and may be located in different business units, branch offices, or other locations. In other cases, the clients 20 may be associated with individual users (i.e., customers) that may wish to interact with other clients 20 and/or a financial institution or entity. In general, the clients 20 may be terminals or platform entities that are capable of executing example embodiments, and there could be as few as one, or a host of such terminals or entities.

In one example use case, the client 20 may be a merchant terminal used to inform a payments platform 50 of a transaction initiated by a customer with the merchant via a payment card 12 (e.g., a credit or debit card) issued by or serviced by the borrower or facilitator. In another example use case, the client 20 may be a cell phone or computer of the customer attempting to initiate a transaction online to purchase a good or service provided by the merchant, and the client application 22 may be a website of the merchant via which the customer provides the payment card 12 or other payment method details to apply for credit from the borrower or facilitator via the payments platform. Example embodiments may, in some cases, specifically apply to financial transactions that involve electronic funds transfers associated with payments (including automatic payments).

Thus, for example, in some cases each one of the clients 20 may include one or more instances of a communication device such as, for example, a computing device (e.g., a computer, a server, a network access terminal, a personal digital assistant (PDA), radio equipment, cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, the network 30 may include or also be operably coupled to an automated clearing house (ACH) network 32 to which one or more instances of a bank entity 34 are also operably coupled. The bank entity 34 (or each of multiple such entities) may include various bank accounts associated with various customers. Such bank accounts may be referred to as customer accounts and customer account 36 in FIG. 1 is one such example of these customer accounts. As noted above, the customer may initiate a financial transaction to purchase a good or service of a merchant. For a debit purchase, the merchant (or customer) may inform the payments platform 50 (or transaction facilitation platform) of the desired transaction so that the customer can arrange the borrower/facilitator to transfer funds to the merchant on his/her behalf to obtain the good or service (e.g., from a for the benefit of (FBO) account of the borrower), and then arrange to transfer funds from the customer account 36 to borrower (facilitator). This transfer of funds from the customer account 36 may occur via the ACH network 32 by provision of an ACH file (or request) submitted by the facilitator to the bank entity 34. The bank entity 34 processes the ACH request and, if sufficient funds are available in the customer account 36, transfers money in the amount of the transaction from the customer account 36 to the facilitator. ACH payments are a form of electronic bank transaction made using a network (i.e., the ACH network 32) that is formed from a system of computers that communicate with each other to make and receive payments. For each transaction there is one computer at the sending end to send a request for payment, and another computer at the receiving end to accept the request. Whereas many customers may imagine that a financial transaction somehow transfers money directly from their accounts into the corresponding accounts of merchants, that is typically not the case. Instead, the card issuer or related entity (as described in more detail below) may transfer money from an account on behalf of the customer to the vendor to support the transaction, and then the card issuer may request an ACH transfer from the customer account to cover the transaction.

In FIG. 1, multiple payment cards 12 are shown along with multiple bank entities 34 and multiple customer accounts 36. Whereas the system 10 supports a multitude of customers, the specific payment cards 12, bank entities 34, and customer accounts 36 of FIG. 1 are meant to be associated with single customer (and corresponding instance of the client application 22). In this regard, each of the specific payment cards 12, bank entities 34, and customer accounts 36 of FIG. 1 are therefore intended to represent the multiplicity of different payment vehicles or payment instruments that are often associated with a single customer. The multiple payment cards 12, bank entities 34, and customer accounts 36 of FIG. 1 should therefore further be understood to be instantiated many thousands and even millions of times within the system 10. Data associated with transactions of this multitude of actors may then further be understood to be happening at massive volume levels each day, and even each hour and minute.

In an example embodiment, devices to which the clients 20 may be coupled via the network 30 may include one or more application servers (e.g., application server 42), and/or a database server 44, which together may form respective elements of a server network 40. Although the application server 42 and the database server 44 are each referred to as “servers,” this does not necessarily imply that they are embodied on separate servers or devices. As such, for example, a single server or device may include both entities and the database server 44 could merely be represented by a database or group of databases physically located on the same server or device as the application server 42. The application server 42 and the database server 44 may include hardware and/or software for configuring the application server 42 and the database server 44, respectively, to perform various functions. As such, for example, the application server 42 may include processing logic and memory enabling the application server 42 to access and/or execute stored computer readable instructions for performing various functions. In an example embodiment, one function that may be provided by the application server 42 may be the provision of access to information and/or services related to payments platform 50, and more particularly relating to facilitating financial computations and calculations related to decisions associated with extensions of credit (e.g., to cover financial transactions). For example, the application server 42 may be configured to provide (via the payments platform 50) execution of instructions, and storage of information descriptive of events or activities, associated with the payments platform 50 and the execution of a financial computations, calculations and modeling on behalf of a user of the system 10 located at one of the clients 20, or interacting with a user located at one of the clients 20, in real time.

In some cases, the financial transaction may include obtaining temporary funds transfer servicing associated with financial transactions, and the activities associated therewith may include the provision of a debit card or account number that can be used to facilitate financial transactions detailing information required by the facilitator (and operator of the payments platform 50) to determine whether credit, funds, or other products can be provided to the customer based on information provided. In some cases, the information provided may be provided by the customer. However, in others, the bank entity 34 may be contacted to determine a status of the customer account 36 (e.g., an account balance therein) to determine how much can safely be advanced on behalf of the customer to support financial transactions. In some cases, the financial transactions may be pay now activities associated with, for example, purchases of goods or services. However, in other cases, the financial transactions may be automatic payments made (or attempted to be made) via one of the payment vehicles (i.e., one of the payment cards 12 or one withdrawal from one of the customer accounts 36 with one of the bank entities 34).

In some embodiments, the payments platform 50 may be a technical device, component or module affiliated with the lender or an agent of the lender. Thus, the payments platform 50 may operate under control of the lender or agent of the lender to be a technical means by which to carry out activities under direction of the lender/agent or employees thereof. The lender may, in some cases, be a facilitator of a transaction between the user (or customer) and a merchant, where such facilitation includes the advancement of funds, provision of a loan or extension of credit to the customer (thereby making the customer a borrower, and the facilitator a lender). The facilitator may, in effect, act via the operation of the payments platform 50 via configuration of various decision making components thereof. Thus, in some cases, the payments platform 50 may effectively act as a facilitation agent.

In some embodiments, the clients 20 may access the payments platform 50 services, and more particularly contact the payments platform 50 online and utilize the services provided thereby. However, it should be appreciated that in other embodiments, an application (e.g., the client application 22) enabling the clients 20 to interact with the payments platform 50 (or components thereof) may be provided from the application server 42 (e.g., via download over the network 30) to one or more of the clients 20 to enable recipient clients 20 to instantiate an instance of the client application 22 for local operation such that the payments platform 50 may be a distributor of software enabling individual users to utilize the payments platform 50. Alternatively, another distributor of the software may provide the client 20 with the client application 22, and the payments platform 50 may communicate with the client 20 (via the client application 22) after such download.

In an example embodiment, the client application 22 may therefore include application programming interfaces (APIs) and other web interfaces to enable the client 20 to conduct operations as described herein via the payments platform 50. The client application 22 may include a series of control consoles or web pages including a landing page, onboarding services, activity feed, account settings (e.g., user profile information), transaction management services, payment management services and the like in cooperation with a service application that may be executed at the payments platform 50. Thus, for example, the client application 22 may enable the user or operator to articulate and submit queries, make credit extension requests, initiate and pay for transactions using funds associated with a credit extension request, and/or the like using the payments platform 50.

In an example embodiment, the application server 42 may include or have access to memory (e.g., internal memory or the database server 44) for storing instructions or applications for the performance of various functions and a corresponding processor for executing stored instructions or applications. For example, the memory may store an instance of the payments platform 50 configured to operate in accordance with an example embodiment of the present invention. In this regard, for example, the payments platform 50 may include software for enabling the application server 42 to communicate with the network 30 and/or the clients 20 for the provision and/or receipt of information associated with performing activities as described herein. Moreover, in some embodiments, the application server 42 may include or otherwise be in communication with an access terminal such as any one of the clients 20 (e.g., a computer including a user interface) via which individual operators or managers of the entity associated with the facilitation agent may interact with, configure or otherwise maintain the payments platform 50. Thus, it should be appreciated that the functions of the payments platform 50 can be conducted via client-server based interactions involving communications between clients 20 and the server network 40, or may be conducted locally at one of the clients 20 after an instance of the payments platform 50 is downloaded (e.g., via or as the client application 22) locally at the corresponding one of the clients 20.

As such, the environment of FIG. 1 illustrates an example in which provision of content and information associated with the financial industry may be accomplished by a particular entity (namely the payments platform 50 residing at the application server 42 or at one of the clients 20). Thus, the payments platform 50 may be configured to handle provision of content and information that are secured as appropriate for the individuals or organizations involved and credentials of individuals or organizations attempting to utilize the tools provided herein may be managed by digital rights management services or other authentication and security services or protocols that are outside the scope of this disclosure.

As noted above, the payments platform 50 may operate to enable the user associated with a given one of the clients 20 to setup an account (i.e., a user account) with an entity (e.g., a lender or facilitator) that operates the payments platform 50 and that, in some cases, may issue, or partner with an issuer of, the payment card 12 to the customer. The user account may be specific to one user (or customer) and may be accessed by the user via the user's respective instance of the client application 22. After account setup, the user may initiate transactions with various merchants via a physical or virtual card supported by the entity in association with the user account. The user account may, in some cases, be linked to the customer account 36 to facilitate access by the facilitator to the customer account 36 in association with conducting financial transactions (e.g., making automatic or pay now payments). In this context, for example, the amount of money in the customer account 36 may be used by the facilitator to determine if a financial transaction initiated by the user associated with the user account is approved or denied by the facilitator. If the transaction is approved, the facilitator may then initiate an ACH pull in order to be reimbursed from the funds in the customer account 36. However, it should be appreciated that ACH is merely one example of an electronic funds transfer to which example embodiments may apply. Thus, the ACH network 32 may be replaced by any electronic funds transfer network in other examples.

In a typical case, the facilitator may be enabled to get a report from the bank entity 34 as to the status of the customer account 36 periodically. For example, upon request or at various intervals, the facilitator may receive an account balance or other status information associated with the customer account 36. Obviously, the facilitator would not want to cover a transaction larger than the current account balance in the customer account 36. However, there remains the problem that the facilitator cannot know in real time what other transaction or money transfers are planned or already being processed that may add money into or take money from the customer account 36. Thus, the facilitator must appreciate that the account balance fluctuates.

In some cases, to account for this natural and normal fluctuation of the account balance of the customer account 36, the facilitator may place a predetermined transaction limit as a function of the account balance at any given time to define a limit to the exposure risk the facilitator is willing to accept. For example, the predetermined transaction limit may be 80% of the account balance at the time the account balance is checked (although any suitable value reflecting the risk tolerance of the facilitator may be chosen). In such a case, similar to the example discussed above, if the customer has $500 as the account balance in the customer account 36, the facilitator may allow the customer to conduct transactions supported by the facilitator in the amount of $400 (i.e., 80% of $500). If the customer employs the payment card 12 (e.g., debit card) or otherwise attempts a transaction online in the amount of $300, the facilitator may approve the transaction and transfer funds to the corresponding merchant accordingly. The facilitator may also generate an ACH file to request transfer of $300 from the customer account 36 to the facilitator to cover or settle the transaction. However, as noted above, ACH transactions may take days to be completely resolved, and it is possible that the customer account 36 may have other transfers out scheduled ahead of the transaction which, if executed, may leave the customer account 36 short of funds when the ACH pull request arrives. Thus, for example, if another transaction or series of transactions were conducted before processing of the ACH request for $300, and the other transaction or series of transactions leave less than $300 remaining in the customer account 36, this situation would result in an insufficient funds notification (NSF return) being sent to the facilitator, and the facilitator would not receive (at least at this time) the money needed to settle the transaction.

In addition to the facilitator having to deal with receipt of the insufficient funds notification, the user or customer associated with the customer account 36 may receive an overdraft fee from his/her bank (e.g., the bank entity 34). In order to guard against this, and potentially other fees that may be associated with various transactions whether supported by ACH or not, particularly with respect to subsequent transactions the customer may attempt to engage in, the facilitator may analyze via request and/or receipt of status update information associated with not only the customer account 36, but a multitude of customer accounts associated with this an many other customers, also covering many bank entities and other organizations, to attempt to determine whether a payment attempt made via one of the payment vehicles associated with the user account is likely to generate costs/fees (and what magnitude of costs/fees) for the facilitator and/or the user or customer associated with the user account and/or whether the payment is likely to be successfully made. Moreover, the facilitator may inform the user of the results of its determination to attempt to avoid failed payments and minimize fees levied on the user or customer associated with the user account. To do this at scale (i.e., for many thousands or even millions of customers) entails a massive computational load that, especially given the real time nature of decisions being made in this context, is far beyond the capabilities of typical computers or servers. Accordingly, the payments platform 50 may employ machine learning (e.g., via ML platform 70) to handle the massive computational load in a real time environment.

The status update information mentioned above may be obtained by the payments platform 70 via the network 30. In this regard, the status update information may include or be embodied as account transaction data 60, which may include frequent account updates from the bank entity 34 that may extend beyond those that are otherwise necessitated by individual transactions or routine periodic checks. These more frequent account updates (e.g., status update information) may be provided in the form of the account transaction data 60 as shown in FIG. 1. The facilitator may also utilize profile information or other local knowledge retained about the customer and/or the customer account 36, which may form part of the status update information, in some cases. Based on the status update information (e.g., the account transaction data 60 and any profile information or local knowledge), the payments platform 50 may utilize the ML platform 70 to determine how to predict payment success and/or minimize fee generation associated with each attempted payment that is undertaken with the payment card 12 or via any other payment vehicle that may result in an ACH or other electronic money transfer from one of the customer accounts 36.

The challenge of processing the massive computational load mentioned above is only further complicated by the fact that the status update information within the account transaction data 60 is often unformatted data. In this regard, for example, the status update information may come in any number of forms of characters and signals that are received from the ACH network 32, from client applications 22, from bank entities 34, and/or the like. The signals include many millions of characters and sequences that may, in some cases, be indicative of costs/fees charged to the facilitator or to the customer or indicative of the success or failure of a payment attempted. The goal of the ML platform 70 is to learn how to monitor this massive volume of information and learn how to spot patterns that can fairly be assumed (and hopefully over time confirmed) to be associated with costs/fees and successful or failed payments, so that the customer can be guided toward selection of payment vehicles that are most likely to lead to successful payments (including automatic payments) and/or to avoid future cost/fee generation for the customer(s) and/or facilitator.

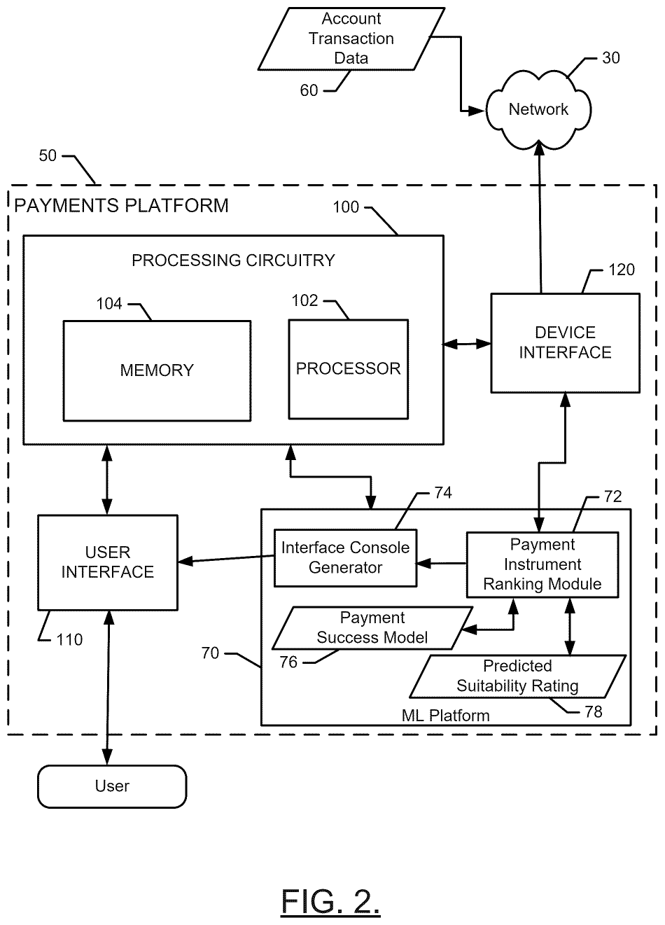

The payments platform 50 (and/or the ML platform 70) may also include a number of components or modules that assist in various aspects of processing the massive volumes of unstructured data and signals mentioned above. For example, the payments platform (and/or the ML platform 70) may include a payment instrument ranking module 72, and an interface console generator 74. Each of these additional components or modules may be integral portions or modules of the payments platform 50 (and/or the ML platform 70), or may be called by the payments platform 50 (and/or the ML platform 70) to perform their respective functions (e.g., via API or other programming calls), or vice versa. Thus, for example, the payment instrument ranking module 72 may include modeling, algorithms, or instructions that enable the payment instrument ranking module 72 to call the ML platform 70 to apply machine learning to the ranking of payment instruments (or payment vehicles) as described in greater detail below. In this regard, in some cases, the ranking may include an identification of successful and/or failed payment attempts and/or an identification of fees in the unstructured signals of the account transaction data 60. Similarly, the interface console generator 74 may include modeling, algorithms, or instructions that enable the interface console generator 74 to call the ML platform 70 to apply machine learning to the identification of a selected interface console to present to the customer for informing the customer of the ranking of the payment instruments and, in some cases, further soliciting input regarding assignment of a selected payment instrument to use for future payments (including automatic payments). More details about the interactions of these components will be discussed below in reference to FIG. 2.

FIG. 2 shows certain elements of an apparatus for provision of the payments platform 50 or other processing circuitry according to an example embodiment. The apparatus of FIG. 2 may be employed, for example, as the payments platform 50 operating at, for example, a network device, server, proxy, or the like (e.g., the application server 42 or client 20 of FIG. 1)). Alternatively, embodiments may be employed on a combination of devices (e.g., in distributed fashion on a device (e.g., a computer) or a variety of other devices/computers that are networked together). Accordingly, some embodiments of the present invention may be embodied wholly at a single device (e.g., the application server 42 or the client 20) or by devices in a client/server relationship (e.g., the application server 42 and one or more clients 20). Thus, although FIG. 2 illustrates the payments platform 50 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating decision making regarding support for financial transactions (e.g., credit, debit, etc.) supported by the technical improvements of an example embodiment is shown. In this regard, the payments platform 50 may be configured to perform analysis, modeling, or other determinations based on the signaling and/or the information provided to determine whether to facilitate a financial transaction on behalf of a customer and, if so, conduct the corresponding transfers of money needed to do so in such a way that is aimed at avoiding the generation of fees for the customer when the transaction is being settled. The apparatus may be an embodiment of the payments platform 50 or a device or component thereof including, for example, the ML platform 70 or its respective modules, engines or components. As such, configuration of the apparatus as described herein may transform the apparatus into the payments platform 50. In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In some embodiments, the processor 102 may be embodied as a central processing unit (CPU) or a graphics processing unit (GPU). In situations where the processing circuitry 100 is embodied as a server or at a remotely located computing device, the user interface 110 may be disposed at another device (e.g., at a computer terminal) that may be in communication with the processing circuitry 100 via the device interface 120 and/or a network (e.g., network 30). Thus, in some cases, the connection of the user to the user interface 110 may actually occur via the network 30.

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be limited or even eliminated in some cases. Alternatively, the user interface 110 may be remotely located.

The device interface 120 may include one or more interface mechanisms for enabling communication with other devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server 44) that may store a variety of files, contents or data sets. Among the contents of the memory 104, applications (e.g., a service application configured to interface with the client application 22) may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the payments platform 50, the ML platform 70, and/or any of the modules listed above (e.g., the payment instrument ranking module 72 and the interface console generator 74) each of which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the payments platform 50, the ML platform 70, the payment instrument ranking module 72, and the interface console generator 74 as described below.

The ML platform 70 may employ one or more instances of a neural network (e.g., a CNN), a support vector machine (SVM), Bayesian network, logistic regression, logistic classification, decision tree, ensemble classifier, gradient boosting machine or other machine learning model to process inputs received by the ML platform 70 to generate outputs as described herein. The ML platform 70 may be supervised (identifying patterns in raw data upon which inference processes are desired to be performed via training examples) or unsupervised (identifying patterns in raw data upon which inference processes are desired to be performed without training examples). In an example embodiment, the ML platform 70 may include a neural network of nodes where each node includes input values, a set of weights, and an activation function. The neural network node may calculate the activation function on the input values to produce an output value. The activation function may be a non-linear function computed on the weighted sum of the input values plus an optional constant. Neural network nodes may be connected to each other such that the output of one node is the input of another node. Moreover, neural network nodes may be organized into layers, each layer comprising one or more nodes. The neural network may be trained and update its internal parameters via backpropagation during training. A CNN may be a type of neural network that further adds one or more convolutional filters (e.g., kernels) that operate on the outputs of the preceding neural network layer to produce and output to then next layer. The convolutional filters may have a window in which they operate, which is spatially local. A node of a preceding layer may be connected to a node in the current layer if the node of the preceding layer is within the window. If not within the window, then the nodes are not connected.

In an example embodiment, training may occur via the provision of training data along with target data that includes desired output data associated achieved from the training data via respective models stored in the memory 104 and accessible to the ML platform 70. Thereafter, when inferences are to be drawn with respect to a new set of data including new information to provide an output that is indicative of options for output, training backpropagation may be provided to update the learning. The information provided to the ML platform 70, and the corresponding outputs to be gained therefrom, may vary. Thus, for example, the ML platform 70 may, in some cases, be employed by the payment instrument ranking module 72 to enhance payment attempt identification along with an indication of the success or failure of the attempt. Additionally or alternatively, the payment instrument ranking module 72 may enhance fee identification performance. In either case, for example, massive amounts of real time account activity across a multitude of instances of the customer account 36 may be simultaneously monitored. Specific potential instances of payment attempts (e.g., by identifying ACH transfers or other electronic money transfers) may be detectable and/or fee charging may be detectable in real time, whereas others may only be detectable by monitoring patterns that play out over longer periods of time. The ML platform 70 may assist in load balancing between real time payment attempt and/or fee detection and post hoc payment attempt and/or fee detection of the payment instrument ranking module 72. As such, the load balancing function may effectively triage massive amounts of data into respective camps that dictate how quickly payment attempt identification and fee detection resources are to be employed for detecting payment and/or fee charging activity. In such capacity, the machine learning module of the ML platform 70 may not only conduct load balancing, but may schedule individual payment and/or fee monitoring activities at specific future times during which resources for fee detection are expected to be available for the corresponding type or priority of data being analyzed for payment success/failure and/or fee charging activity.

Specifically with respect to fee identification, patterns that can be detected by the ML platform 70 may include searches for known fee codes or signals, and for known fee amounts in a given range of values that are known to correspond to typical fee charges. In this regard, for example, for many organizations, fees charged may be in the range of $20 to $80, with $35 being a very common fee charge. In some cases, the ML platform 70 may further associate specific fee amounts with corresponding entities (e.g., banks) that are known to charge the specific fee amount. Thus, for example, the ML platform 70 may be trained to identify that Acme bank tends to charge insufficient fund return fees of $35, whereas Beta bank may charge a similar fee of $40. The ML platform 70 may cooperate with the payment instrument ranking module 72 to ensure that for transactions associated with Acme bank, any apparent fees of $35 are strongly weighted to be considered to be fee charges that can be considered for suitability ranking (with the assumption that ranking may be performed to minimize fees). Meanwhile, for any transactions associated with Beta bank, similar weighting may be provided to any possible fee charges at $40. By these means, higher confidence that a fee has been charged may be obtained, and the payment instrument ranking module 72 may rank the payment instrument that charges the corresponding fees accordingly.

Another example pattern that may be used for fee detection may be the temporal proximity of an apparent dollar value amount charged, or at least associated with an amount involved in a transaction, to the transaction. Thus, for example, if Acme bank is known to charge its insufficient fund return fees within a same business day as a transaction, any potential fee that falls on the same business day as a transaction may be weighted by the ML platform 70 for more likely identification as an actual fee that should be avoided (thereby triggering action from the payment instrument ranking module 72). However, a potential fee hitting three days after the last transaction may be weighted very lightly, and therefore may not trigger action from the payment instrument ranking module 72. Meanwhile, if Beta bank is known to (or can be learned to) charge its insufficient fund return fees in a range of two to three business days after a transaction, the weighting of potential fees by the ML platform and payment instrument ranking module 72 may be handled accordingly.

Still another example of pattern detection upon which the ML platform 70 may be trained may include a text component or naming convention used for a fee string. Thus, for example, if Acme bank is known to (or can be learned) to preface or otherwise associate its fee charges with a given text string or name, the corresponding text string or name may be learned and any numerical value associated with the learned text string or name can be identified by the ML platform 70 as being a potential fee that may be desirable to avoid.

In relation to payment attempt success/failure, the charging of a fee may often be an indication of the failure of a payment. Thus, not only can fee charging influence payment instrument ranking due to a potential desire to minimize fee charging more generally, but the fee charging may also indicate when a fee attempt has failed. Moreover, there are many predictors or both success and failure of payment attempts that may be learned and monitored by the ML platform 70. Those predictors may themselves be included or encoded in data strings, characters, or other variously formatted data that may differ for different organizations and therefore also for different payment instruments. As such, the ML platform 70 may be trained to identify predictors of payment success and failure, and such training may be reinforced by human affirmation, or automatically via additional monitoring and reinforced learning. Predictors of failure may include a lack of validation of a payment instrument, a failed ACH or payment card response code (e.g., no account, or invalid credit card number), fraudulent response codes, known closed accounts (e.g., no account), known institutional reliability (e.g., since some banks or institutions may be more reliable than others for facilitating payments), cards reported lost or stolen, expired cards, prepaid cards, etc. Each predictor of failure may be weighted or ranked according to its expected influence on a current or future payment attempt using the corresponding payment instrument.

Predictors of success may include one or more instances of successful payments using the payment instrument in question. These successful payments may be made in the same or different contexts (e.g., for automatic payments or one-time/pay now payments) and, regardless of context, are typically the strongest indicators of future success. Thus, successful payments typically weigh heavily positive with respect to predicting success (particularly if temporally recent). However, further within the context of successful payments, it may be appreciated that recent success is a stronger indicator of current and future success than success in the distant past. The number of successes using a particular payment instrument is also a strong indicator of current or future success, either alone or together with temporal considerations. Other predictors of success may include (as noted above) the institution involved, as some institutions tend to have higher likelihood of success often due to their own stringent internal policies. Validated accounts typically predict a higher likelihood of success for future payments as well. Each predictor of success may be weighted or ranked according to its expected influence on a current or future payment attempt using the corresponding payment instrument. Thus, it may be appreciated that a payment success model 76 may be built with all the weights assigned for each individual predictor of success and failure.

The payment instrument ranking module 72 may therefore utilize the weighted information from the payment success model 76 to determine a predicted suitability rating 78 for each payment instrument of which the payment instrument ranking module 72 has awareness. The predicted suitability rating 78 may include a payment success ranking (or predicted success rating) indicating a likelihood of success using the payment instrument that is ranked for a current or future payment and/or a cost or fee ranking (or predicted cost/fee rating) indicating a likelihood for having a cost to the facilitator or a fee charged to the customer for using the payment instrument that is ranked and in some cases also the magnitude of the cost/fee. Thus, it can be appreciated that the predicted suitability rating 78 may be instantiated as the predicted success rating, as the predicted cost/fee rating, or as a combination of the predicted success rating and the predicted cost/fee rating.

Accordingly, training data used for training of the payment instrument ranking module 72 (or ML platform 70 more generally) may be selected based on its inclusion of known information relevant to payment success/failure likelihood and/or costs/fees from ad hoc analysis. However, in some cases, the facilitator may use data relating to situations where the facilitator is aware that its own actions caused the generation of a fee or its own experience with handling a payment failure or success using a particular instrument. In fact, these situations may present the strongest training data since the existence of an actual success, failure and/or cost/fee may be known and therefore examination of text strings, temporal factors, and dollar amounts charged may all be conducted with the full assurance that an actual success, failure or fee occurred, so maximum weight can be given to the training example, and any correlations to similar patterns or situations detected in the future.

In some cases, the information learned about a particular bank, card issuer or other entity may be used to define a payment instrument profile that may be used by the ML platform 70 for any customer account 36 known to be associated with the bank, card issuer or other entity to which the payment instrument profile applies. The payment instrument profile may have a validity ranking associated therewith, and the validity ranking may be determined based on an overall weight or strength of various factors tending to indicate the strength of correlations made for the corresponding bank or third party to payment and fee behaviors. In some cases, the validity ranking may also have a temporal component relating to how recently the behaviors have been experienced. Moreover, in some cases, payment and fee behaviors may be further specifically associated with individual products, divisions, of subsidiaries of a given bank or other entity. As the products are marketed and replaced by other products, the behaviors associated with earlier products may cease to be noted or may change with subsequent future products. Thus, the temporal aspect of validity ranking can ensure that old data does not dominate current payment instrument ranking strategies.

In a case where a training database is desired, identification of training data may be obtained by identifying situations with known payment success, failure or fee charges, and studying the signals associated with the situations to build the training data set. Knowing which signals actually include data indicative of payments and/or fees can be accomplished, as noted above, when the facilitator's own actions were involved in the payment and/or fee. However, for better learning, more comprehensive data sets may be desired. Surveys of customers or banks may be one way to obtain additional identifications of payment and/or fee generation scenarios. But surveys may be annoying to customers or banks, and participation may be spotty in any case. To obtain more data including reliable payment and/or fee scenarios from which to train, the ML platform of an example embodiment may employ generative artificial intelligence (AI) to find public records, social media posts, message boards or other clues to situations or scenarios that generated fees or involved payment failure or success. For example, social media posts may identify customer complaints or problem resolution records involving failed payments or fees associated with data strings accessible to the facilitator and therefore usable for improving data sets via training. The more accurate training data can be with the littlest impact on customers and banks, the more desirable the result may be for the facilitator. The ML platform 70 may therefore be constructed and managed with those goals in mind.

Once payment instruments have been ranked, a continuously updated learning cycle may be commenced for every additional piece of data that is relevant to existing rankings or ratings. Thus, the ML platform 70 may continuously update its models and ratings. Predicted suitability rating generation may be used to engage directly with the user/customer to attempt to avoid future payment failures and/or to minimize the cost (to the facilitator and/or the user). The continuous updating of such information in real time (or even post hoc) can only be accomplished in light of the massive amounts of unstructured data involved, using the ML platform 70. However, even the difficult task of processing such large volumes of information is only useful if it is put into practice in a useful way. The interface console generator 74 provides the utility for the information generated by enabling informed decisions to be made by the user/customer in a way that may enhance the user experience with respect to making payments including automatic payments.

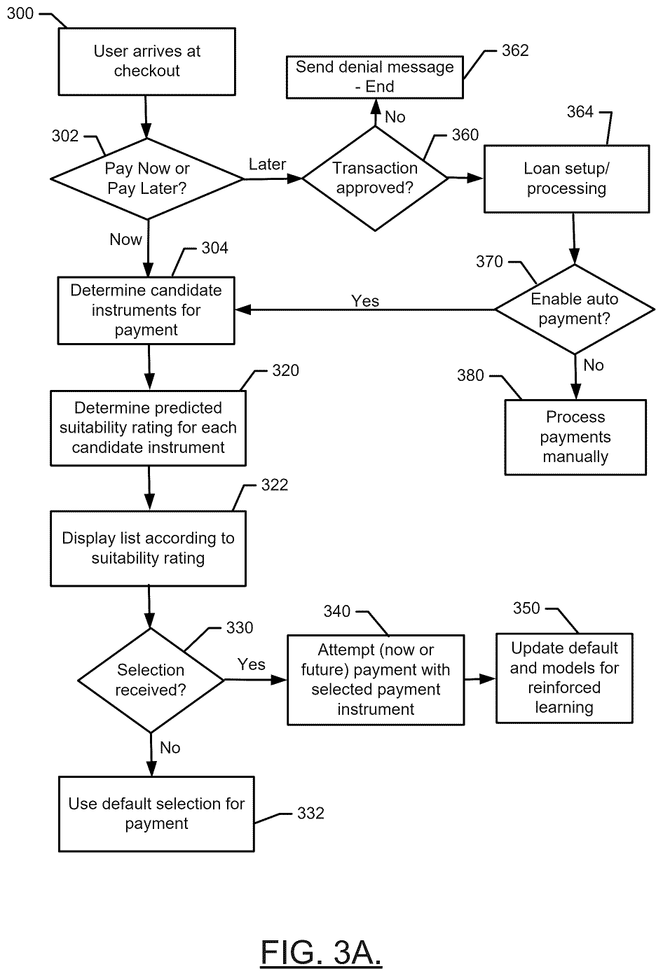

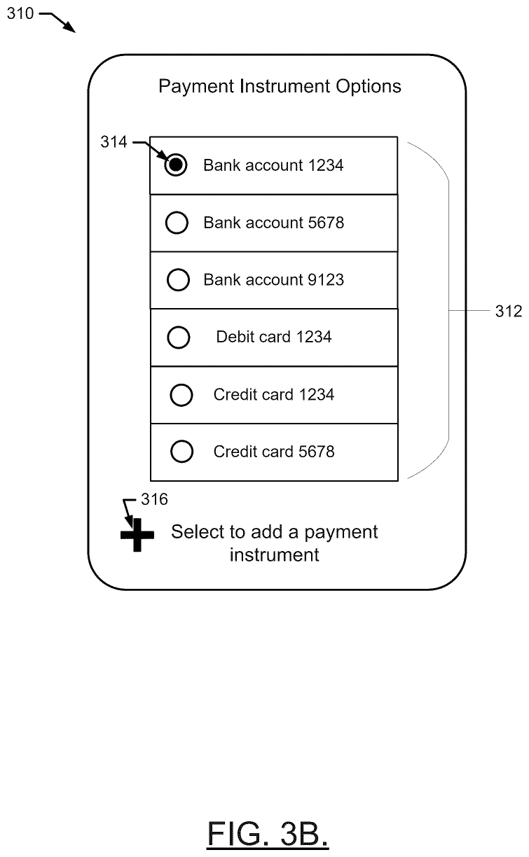

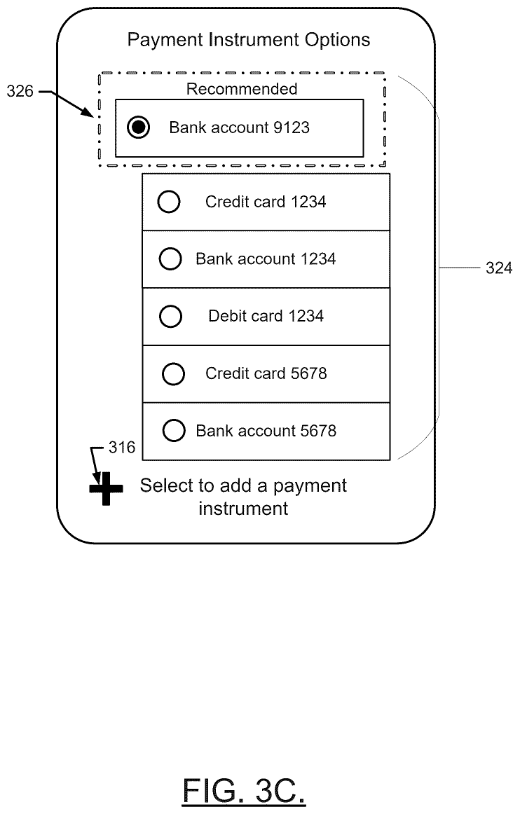

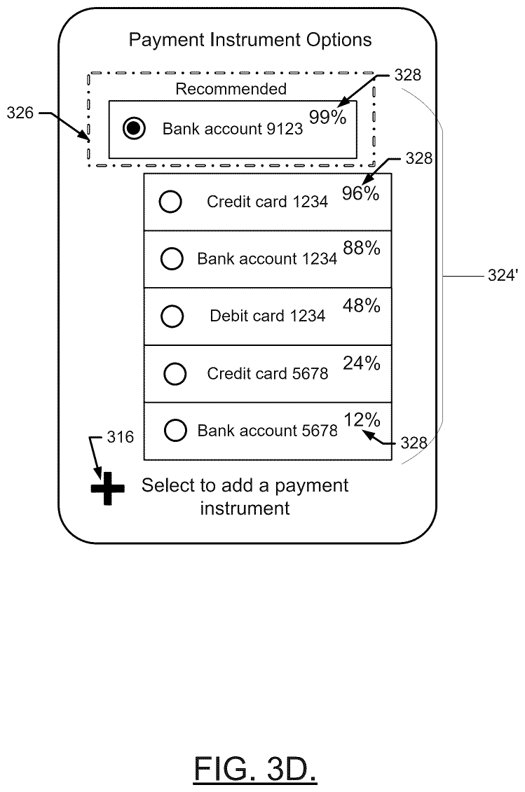

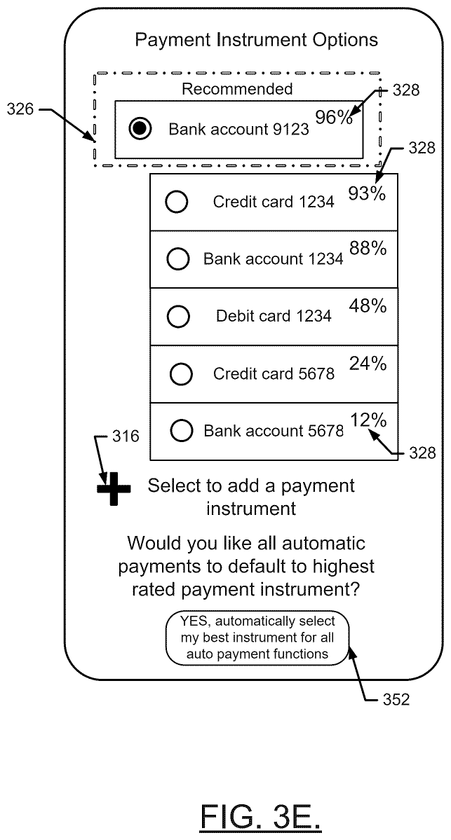

The interface console generator 74 may therefore generate a unique display for the user, which allows the user to evaluate and make decisions about what payment instrument is the best one to use in terms of avoiding payment failure and/or minimizing cost. A process in which that display is generated is demonstrated in the block diagram of FIG. 3A. In this regard, as shown in FIG. 3A, the user may arrive at checkout (e.g., via the client application 22) at operation 300. The user may be attempting to complete a transaction for a product or services, and the checkout stage may be the stage at which the user provides payment to complete the transaction. At operation 302, the user may be asked whether to complete the transaction as a pay now or pay later transaction. Notably, this decision could be skipped in some cases, and the transaction could already be proceeding as one or the other of a pay now or pay later transaction, but the decision option is shown here to demonstrate that both options are supported and may even be supported responsive to giving the user a conscious decision option.

If the user selects to pay now, or if the transaction is a pay now transaction anyway, flow may proceed to operation 304, at which point a determination may be made as to what candidate instruments are known for this user for the purposes of making a payment. In this regard, a user profile kept or built by the facilitator may include a list of customer accounts 36 and/or payment cards 12 as shown in FIG. 1. FIG. 3B shows a control console 310, which may be generated to include a list of payment instrument options 312 that may be used to make a payment. The list of payment instrument options 312 may include all payment instruments that are known to be associated with the user. A selected or default option may be shown by selection indicator 314. The selected or default option may be the last one used by the user for a payment, or a previously set up default or selected instrument selected by the user for a prior payment. As shown generally in FIG. 3B. the list of payment instrument options 312 may be augmented by selecting modification selector 316. Responsive to selection of the modification selector 316, the user may be enabled to provide detailed information about another (not yet listed) payment instrument option that the user may wish to use (or at least have as an option for use) in the future.

Returning to FIG. 3A, and as noted above, the payment instrument ranking module 72 may generate predicted suitability ratings for each candidate instrument (i.e., each of the payment instrument options in the list of payment instrument options 312) at operation 320 and the list may be displayed at operation 322. The list of payment instrument options 312 may be modified based on the predicted suitability ratings calculated. FIG. 3C shows an updated list of payment instrument options 324, but further illustrates one of the payment instrument options on top of the list as a recommended instrument 326. FIG. 3D shows the updated list of payment instrument options 324′ further augmented with the predicted suitability rating 328 of each option displayed. This predicted suitability rating 328 is shown as a percentage, which may be a likelihood of success (or failure), cost, or a combination rating, as noted above.

At operation 330, a determination may be made as to whether the user selects one of the payment instrument options as a selected payment instrument options. If the user does not, then a default selection may be used for the payment at operation 332. However, if the user does select one of the options, payment may be attempted at operation 340 with the selected payment instrument. Any next attempt may then use the selected payment instrument as well since, at operation 350, the default selection may be updated and all models may also be updated for reinforced learning. In some cases, as shown in FIG. 3E, the user may be prompted to allow the “best” instrument option to be the default option for all future payments. Within this context, the “best” instrument option may be understood to be the payment instrument option having the highest predicted suitability rating (which may mean that the option has the lowest cost and/or predicted failure rate). Selection 352 in FIG. 3E provides the option for automatic selection of the best option going forward.

As noted above, the discussion of operations 304 to 350 was provided in the context of a pay now transaction. If instead, the transaction is a pay later transaction or the user selected a pay later option at operation 302, flow may proceed to operation 360 at which point a determination is made as to whether the transaction is approved 360. If not approved, which likely means that the user does not qualify for a loan, then a denial message may be sent at operation 362. However, if approved, then loan setup and processing may occur at operation 364. Part of the loan setup process may include providing the user with an option (e.g., via display of a control console at the client 20 of the user) to set up automatic payments in the future. The control console may provide options for the size of payment, the frequency, and/or any other needed parameters that must be agreed upon or accepted. A determination may then be made at operation 370 as to whether the user selected to enable automatic payment. If the user has not enabled automatic payment at operation 370, flow may proceed to operation 380 and future payments may be set up or processed manually at each payment interval. However, if automatic payment is enabled at operation 370, then flow may proceed to operation 304. The automatic payment may be treated the same as the payments discussed above in relation to each of operations 304 to 350 of FIG. 3A.

In addition to being leveraged for accurate and real-time or near real time updating of predicted suitability ratings, the ML platform 70 may also be utilized by the interface console generator 74 to employ learning with respect to the timing, presentation, form and/or formatting of the control console 310. In this regard, for example, the ML platform 70 may study interactions with all of a multitude of users, many of which may employ different types of hardware and yet may also have similar patterns of behavior, or commonalities with respect to payment instruments associated therewith. The ML platform 70 may therefore tailor the timing, presentation, form and/or formatting of the control console 310 to account for the different types of hardware, and/or commonalities between users to ensure that the best user experience can be achieved and also maximize the likelihood of user selection of the best payment instrument option. In this regard, if a certain presentation style, or certain augmentation (like the showing of cost, failure/success rate, or other factors) is more likely to get a response from the user, the ML platform 70 may provide input to the interface console generator 74 to direct adoption of the certain presentation style, or certain augmentation. Other enhancements or guidance strategies may further be tested and implemented in time using machine learned guidance.

In an example embodiment, the ML platform 70 may offer the customer and/or merchants opportunities to enhance the data and learning by providing feedback. In either case, confirmation of successful (or failed) payment or a fee charge (including the amount) may be requested from the customer or merchant. If confirmed, the confirmation may be used to identify a scenario that should be considered for updating of the training data or otherwise improving machine learned information gathering. Any associated models may also be updated to change weighting or validate scoring techniques as well.

As discussed above, the training data used to train the ML platform 70 may be selected by the facilitator ahead of time to include merchants, products, and categories thereof that are known by the facilitator through past experience to follow various known patterns with respect to processing successful (or failed) payments and/or fee generation. The known patterns may be used to build models that can infer relationships based on pieces of data that suggest the potential existence of the known patterns. However, every time a payment is attempted or fee is charged, whether determined manually or automatically by the ML platform 70, or through input by the facilitator, merchants, or customers, the ML platform 70 and its respective models (e.g., category, customer, bank/merchant, or other entity specific models) may also be updated. Failures to identify successful payments or fees may also train models, as negative instances of payment processing and fee charging behaviors. Moreover, the ML platform 70 may also be trained to address other interactions with the customer that may enhance the customer experience so that, over time, the customer experience is continuously enhanced.

Regardless of the specific form of the ML platform 70, machine learning may be performed to perform inferences with respect to massively large volumes of data that would take normal computer processing very long periods of time to handle. The ML platform 70 can handle massive volumes of data, and identify the data pertinent to a given user, a given bank, a given situation or scenario, etc., within constraints that may be unique to the given user, bank, situation, etc., in the context of mountains of information, within seconds, whereas doing so with conventional processing tools (i.e., without machine learning) would take orders of magnitude longer periods of time. Moreover, a successful payment made in the morning may influence operations later in the afternoon on the same day. The ML platform 70 therefore enables an acceleration of the processing needed to conduct processing of data, but also to find deep patterns that are meaningful with respect to providing options that are most likely to be acceptable to the given user or situation within constraints that apply. The result is therefore not merely a faster process than the prior process, but a process that is markedly different at its core since the speed changes what is possible to accomplish and therefore creates an entirely new scenario that did not previously exist (and could not have existed) without the tools described herein.

In some example embodiments, the client application 22 may be used in connection with running queries, models, or calculations that are then used as the basis for interactions between the customer and merchants, and/or the lender/agent, or between decision makers within the organization in relation to services provided to customers, or policy decisions and budgeting that is to be done by the organization under control of the payments platform 50. In this regard, for example, the client application 22 may be used to engage (e.g., via a website and corresponding APIs) with the payments platform 50 to select individual products, financial transactions, loans, or types of loans to be evaluated using services associated with the payments platform 50. The payments platform 50 may prompt the client 20 to provide product or transaction details, or other information associated with the financial transaction that is being evaluated. In other words, the client 20 may provide a user interface function for interacting with the payments platform 50 to identify the information that will be evaluated using the payments platform 50.

Regardless of how the queries, calculations or modeling activities are initiated, the payments platform 50 of FIG. 1 may be used to manage execution of such activities. Each of these activities may have its own respective timing and calculations and communications that are facilitated by the payments platform 50 and various components of the payments platform 50 may be conducted in parallel. The components, which may be functional modules that operate via API or function calls to respective segmented platforms or a monolith or other collection of rules, policies, instructions, or the like. In an example embodiment, the payments platform 50 may include (or be operably coupled to) one or both of the ML platform 70 and various component modules described in reference to FIG. 2.

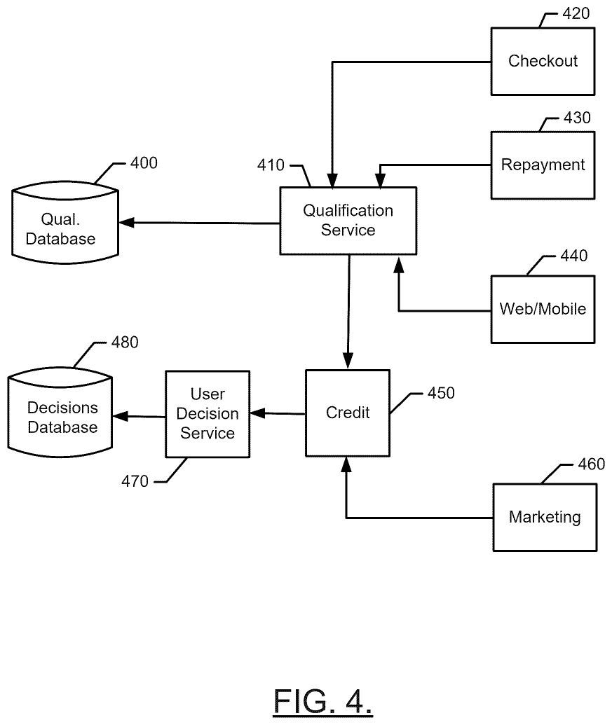

The method of FIG. 3 and the hardware described in reference to FIG. 2 are merely examples of methods and hardware that could be employed to implement example embodiments. Moreover, in some cases, various services or systems may cooperate to practice example embodiments, and different combinations of hardware and software may be employed to implement such services and systems. FIG. 4 is a block diagram of various systems interactions that may be employed to implement an early capture capability in accordance with an example embodiment.

As shown in FIG. 4, a qualification database 400 may store information associated with qualification of a plurality of users, each having a corresponding user account setup and maintained as described above. In an example embodiment, the qualification database 400 may be a portion of the database server 44 of FIG. 1, or implemented in memory 104 of FIG. 2. A qualification service 410 may interface with and update the qualification database 400. The qualification service 410 may be implemented from the payments platform 50.

Checkout information may be provided to the qualification service 410 by various checkout systems 420 associated with respective different vendors or websites. Repayment information may also be provided to the qualification service 410 by various repayment systems 430 associated with respective different vendors or websites. Web or mobile devices 440 may be examples of clients 20 that may interact with the qualification service 410 to setup user accounts and to initiate transactions (via the checkout systems 420) or may payments (via the repayment systems 430).

Credit system 450 may be employed to make credit extension decisions based on information from the qualification service 410, and to augment (or boost) credit limits based on marketing information from a marketing system 460, which may indicate when particular boosts, enhancements, or incentives for various merchants are applicable. A user decision service 470 may be used to consider early capture as described above in reference to operations 300 to 380 in FIG. 3. All information resulting from these decisions may be recorded in decisions database 480.

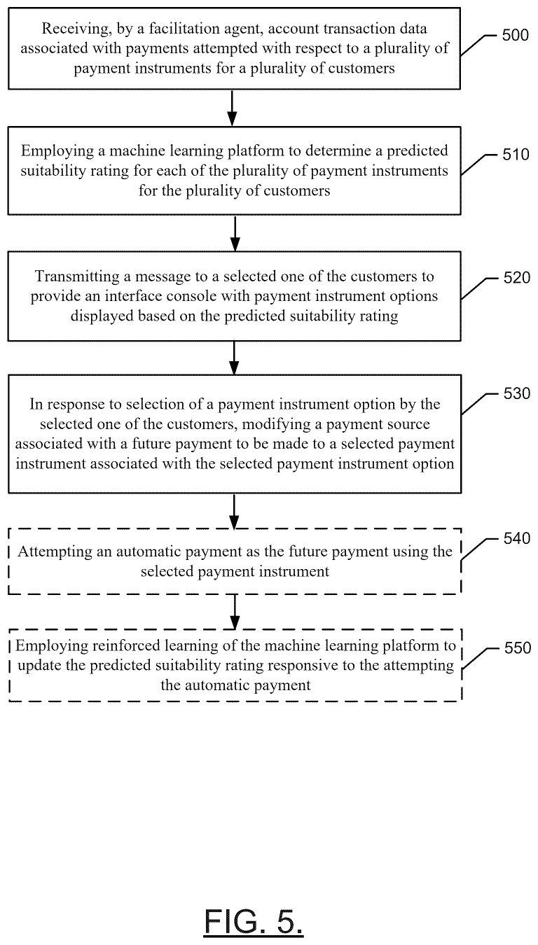

From a technical perspective, the payments platform 50 described above may be used to support some or all of the operations described above. As such, the apparatuses described in FIGS. 2 and 4 may be used to facilitate the implementation of several computer program and/or network communication based interactions. As an example, FIG. 5 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 42, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method for automatically avoiding failed customer payments with respect to electronic fund transfers according to one embodiment of the invention is shown in FIG. 5. The method may be performed by a facilitation agent at a server, computer or other processing circuitry associated with a facilitator. The method may include receiving, by a facilitation agent, account transaction data associated with payments attempted with respect to a plurality of payment instruments for a plurality of customers at operation 500, and employing a machine learning platform to determine a predicted suitability rating for each of the plurality of payment instruments for the plurality of customers at operation 510. The method may further include transmitting a message to a selected one of the customers to provide an interface console with payment instrument options displayed based on the predicted suitability rating at operation 520, and in response to selection of a payment instrument option by the selected one of the customers, modifying a payment source associated with a future payment to be made to a selected payment instrument associated with the selected payment instrument option at operation 530. An optional operation 540 may further provide for attempting an automatic payment as the future payment using the selected payment instrument. An optional operation 550 may further provide for employing reinforced learning of the machine learning platform to update the predicted suitability rating responsive to the attempting the automatic payment.

In an example embodiment, an apparatus for performing the method of FIG. 5 above may comprise a processor (e.g., the processor 102) or processing circuitry configured to perform some or each of the operations (500-550) described above. The processor may, for example, be configured to perform the operations (500-550) by performing hardware implemented logical functions, executing stored instructions, or executing algorithms for performing each of the operations. In some embodiments, the processor or processing circuitry may be further configured for additional operations or optional modifications to operations 500 to 550.

In some embodiments, the method (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, the predicted suitability rating may include a predicted success rating determined for the each of the payment instrument options. In an example embodiment, the predicted success rating may be determined based on weighted factors including instrument age, last usage, success or failure rate for each of the plurality of payment instruments. In some cases, the success or failure rate may be temporally segmented and each segment may be weighted differently based on different periods of time. In an example embodiment, the predicted suitability rating may further include a predicted cost rating determined for the each of the payment instrument options. In some cases, the machine learning module may determine a risk, score or other representation proportional to costs/fees associated with usage of the each of the payment instrument options responsive to cost/fee identification in unstructured data associated with electronic payments. In an example embodiment, transmitting the message may occur automatically in response to the selected one of the customers using an application to define an automatic payment, and modifying the payment source may include insertion of the selected payment instrument into the application for use with the future payment. In some cases, the interface console may display an option to enable all future automatic payments to automatically employ a payment instrument having a highest currently calculated predicted suitability rating to be the payment source for a next instance of the future payment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A method for automatically avoiding failed customer payments with respect to electronic fund transfers, the method comprising:
receiving, by a facilitation agent, account transaction data associated with payments attempted with respect to a plurality of payment instruments for a plurality of customers;
employing a machine learning platform to determine a predicted suitability rating for each of the plurality of payment instruments for the plurality of customers;
transmitting a message to a selected one of the customers to provide an interface console with payment instrument options displayed based on the predicted suitability rating; and
in response to selection of a payment instrument option by the selected one of the customers, modifying a payment source associated with a future payment to be made to a selected payment instrument associated with the selected payment instrument option,
wherein the machine learning platform is updated during operation via training back propagation using post hoc analysis of model performance with respect to determining the predicted suitability rating based on indications of successes and failures, and
wherein the machine learning platform performs load balancing between real-time determination of the predicted suitability rating and the post hoc analysis.

2. The method of claim 1, further comprising attempting an automatic payment as the future payment using the selected payment instrument.

3. The method of claim 2, further comprising employing reinforced learning of the machine learning platform to update the predicted suitability rating responsive to the attempting the automatic payment.

4. The method of claim 1, wherein the predicted suitability rating includes a predicted success rating determined for the each of the payment instrument options.

5. The method of claim 4, wherein the predicted success rating is determined based on weighted factors including instrument age, last usage, success or failure rate for each of the plurality of payment instruments.

6. The method of claim 5, wherein the success or failure rate is temporally segmented and each segment is weighted differently based on different periods of time.

7. The method of claim 4, wherein the predicted suitability rating further includes a predicted cost rating determined for the each of the payment instrument options.

8. The method of claim 5, wherein the machine learning module determines costs or fees associated with usage of the each of the payment instrument options responsive to cost or fee identification in unstructured data associated with electronic payments.

9. The method of claim 1, wherein transmitting the message occurs automatically in response to the selected one of the customers using an application to define an automatic payment, and
wherein modifying the payment source inserts the selected payment instrument into the application for use with the future payment.

10. The method of claim 1, wherein the interface console displays an option to enable all future automatic payments to automatically employ a payment instrument having a highest currently calculated predicted suitability rating to be the payment source for a next instance of the future payment.

11. An apparatus for execution by a facilitation agent to automatically avoid failed customer payments with respect to electronic fund transfers, the apparatus comprising processing circuitry configured to:
receive, by the facilitation agent, account transaction data associated with payments attempted with respect to a plurality of payment instruments for a plurality of customers;
employ a machine learning platform to determine a predicted suitability rating for each of the plurality of payment instruments for the plurality of customers;
transmit a message to a selected one of the customers to provide an interface console with payment instrument options displayed based on the predicted suitability rating; and
in response to selection of a payment instrument option by the selected one of the customers, modify a payment source associated with a future payment to be made to a selected payment instrument associated with the selected payment instrument option,
wherein the machine learning platform is updated during operation via training back propagation using post hoc analysis of model performance with respect to determining the predicted suitability rating based on indications of successes and failures, and
wherein the machine learning platform performs load balancing between real-time determination of the predicted suitability rating and the post hoc analysis.

12. The apparatus of claim 11, wherein the processing circuitry is further configured to attempt an automatic payment as the future payment using the selected payment instrument.

13. The apparatus of claim 12, wherein the processing circuitry is further configured to employ reinforced learning of the machine learning platform to update the predicted suitability rating responsive to the attempting the automatic payment.

14. The apparatus of claim 11, wherein the predicted suitability rating includes a predicted success rating determined for the each of the payment instrument options.

15. The apparatus of claim 14, wherein the predicted success rating is determined based on weighted factors including instrument age, last usage, success or failure rate for each of the plurality of payment instruments.

16. The apparatus of claim 15, wherein the success or failure rate is temporally segmented and each segment is weighted differently based on different periods of time.

17. The apparatus of claim 14, wherein the predicted suitability rating further includes a predicted cost rating determined for the each of the payment instrument options.

18. The apparatus of claim 15, wherein the machine learning module determines costs or fees associated with usage of the each of the payment instrument options responsive to cost or fee identification in unstructured data associated with electronic payments.

19. The apparatus of claim 11, wherein transmitting the message occurs automatically in response to the selected one of the customers using an application to define an automatic payment, and
wherein modifying the payment source inserts the selected payment instrument into the application for use with the future payment.

20. The apparatus of claim 11, wherein the interface console displays an option to enable all future automatic payments to automatically employ a payment instrument having a highest currently calculated predicted suitability rating to be the payment source for a next instance of the future payment.
